(19) United States
(12) Patent Application Publication
(10) Pub. No.: US 2020/0020259 A1
(43) Pub. Date: Jan. 16, 2020

(54) SIGNAGE APPARATUS AND METHOD FOR OPERATING THEREOF

(71) Applicant: LG ELECTRONICS INC., Seoul (KR)

(72) Inventors: Keun Sang Lee, Seoul (KR); Jun Min Lee, Seoul (KR); Young Man Kim, Seoul (KR); In Ho Lee, Seoul (KR)

(73) Assignee: LG ELECTRONICS INC., Seoul (KR)

(21) Appl. No.: 16/582,721

(22) Filed: Sep. 25, 2019

(30) Foreign Application Priority Data
Sep. 2, 2019 (KR) 10-2019-0108404

(51) Int. Cl. G09F 27/00; G10L 15/28; G06K 9/00

(52) U.S. Cl. CPC G09F 27/005; G06K 9/00362; G10L 15/28

(57) ABSTRACT

Disclosed are a signage apparatus and an operation method thereof capable of voice recognition in a 5G environment. A signage apparatus according to an embodiment of the present disclosure, may include as the signage apparatus configured to recognize a voice, a left microphone group and a right microphone group installed on both side surfaces of a display panel, respectively, a sensor configured to sense a user located within a predetermined distance with respect to the display panel, and to confirm the user's position, and an adjuster configured to adjust the arrangement of the left microphone group and the right microphone group, respectively, based on the user's position, and each of the left microphone group and the right microphone group may include a first microphone located at a distance relatively close to the display panel and a second microphone located at a distance relatively far away from the display panel.

### CROSS-REFERENCE TO RELATED APPLICATION

This present application claims benefit of priority to Korean Patent Application No. 10-2019-0108404, entitled “SIGNAGE APPARATUS AND METHOD FOR OPERATING THEREOF” and filed on Sep. 2, 2019, in the Korean Intellectual Property Office, the entire disclosure of which is incorporated herein by reference.

### BACKGROUND

### 1. Technical Field

The present disclosure relates to a signage apparatus and an operation method thereof, which may recognize voice in addition to a touch.

### 2. Description of Related Art

A signage apparatus is a medium installed in a public place (for example, in a subway) or a commercial space (for example, a shopping mall) to provide various contents, commercial advertisements, and the like.

The signage apparatus has been initially simple large billboard, a LCD video in a subway or a bus, PDP advertisement in a subway station, a Digital Information Display (DID), and the like.

A recent signage apparatus has evolved beyond simple information provision and advertisement exposure function to enable interactive communication that may induce public participation through a touch pad technology, a high-speed internet technology, and the like.

Meanwhile, when using the signage apparatus, a user may search for desired information through a touch recognition method, but as voice utilization and frequency of use of a smart device (for example, a smart phone, an artificial intelligence speaker, etc.) increase, the user feels convenience of the voice service, such that even when using the signage apparatus, there is an increasing demand for utilizing the voice recognition method.

Meanwhile, the related art 1 discloses a signage apparatus for sensing a sound, generating a keyword from the sensed sound, and then displaying advertisement contents corresponding to the keyword. In addition, the related art 2 discloses a signage apparatus for displaying contents matching the input voice data.

However, the related art 1 and the related art 2 may recognize the voice and provide the contents related to the recognized voice in the signage apparatus, but there is a limitation to accurately recognize the user's voice as the surrounding noise or the position for each user is different.

Accordingly, there is a need for a technology capable of accurately recognizing the user's voice and providing service information desired by the user.

### RELATED ART DOCUMENTS

### Patent Documents

[Related Art 1] Korean Patent Application Publication No. 10-2017-0130244 (published on)

[Related Art 2] Korean Patent Application Publication No. 10-2016-0027576 (published on)

### SUMMARY OF THE DISCLOSURE

An object of an embodiment of the present disclosure is to provide a signage apparatus and method, which may adjust the arrangement of first and second microphones in a left microphone group and first and second microphones in a right microphone group installed at both side surfaces of a display panel, respectively, based on the user's position, and extract a voice signal having improved sound quality from surrounding sounds obtained, respectively, through the adjusted left microphone group and right microphone group through a signal processing processes (for example, Time Frequency (T-F) conversion, sound source separation, beam-forming, or noise removal), thereby accurately recognizing the voice.

Another object of an embodiment of the present disclosure is to install a first directional microphone as a left microphone group and a second directional microphone as a right microphone group on both side surfaces of a display panel, thereby reducing the width of a signage apparatus by further reducing a space where the microphone is installed compared to when first and second non-directional microphones requiring a spacing distance therebetween are installed, and accurately recognizing the user's voice even while simplifying a signal processing process of extracting a voice signal from surrounding sounds obtained through first and second directional microphones.

In addition, still another object of an embodiment of the present disclosure is to adjust the arrangement of microphones installed on both side surfaces of a display panel based on at least one information of the distance from the display panel to the user's position (that is, an utterance distance) and the width of the display panel, thereby accurately recognizing the user's voice even if the user's position is changed each time, or the width of the display panel is variously produced.

An embodiment of the present disclosure may be a signage apparatus including a left microphone group and a right microphone group installed on both side surfaces of a display panel, respectively, a sensor configured to sense a user located within a predetermined distance with respect to the display panel, and to confirm the user's position, and an adjuster configured to adjust the arrangement of the left microphone group and the right microphone group, respectively, based on the user's position, and each of the left microphone group and the right microphone group includes a first microphone located at a distance relatively close to the display panel and a second microphone located at a distance relatively far away from the display panel.

An embodiment of the present disclosure may be a signage apparatus in which the adjuster generates a first virtual line by connecting the first microphone and the second microphone, which have been spaced at a predetermined interval apart from each other and installed at the same height, generates a second virtual line by connecting the center of the first virtual line and the user's position, and adjusts the arrangement of the first microphone and the second microphone so that the first virtual line and the second virtual line are perpendicular to each other.

An embodiment of the present disclosure may be a signage apparatus in which the adjuster determines the arrangement angle between the lateral direction of the display panel and the first virtual line according to the arrangement adjustment of the first microphone and the second microphone, and the wider the width of the display panel is, the larger the arrangement angle is determined, and the farther the distance from the display panel to the user's position is, the smaller the arrangement angle is determined.

An embodiment of the present disclosure may be a signage apparatus in which the first microphone and the second microphone are a non-directional microphone.

An embodiment of the present disclosure may be a signage apparatus further including a converter configured to convert a first surrounding sound of a time domain obtained through the first microphone of each of the left microphone group and the right microphone group, and a second surrounding sound of the time domain obtained through the second microphone of each of the left microphone group and the right microphone group into a frequency domain.

An embodiment of the present disclosure may be a signage apparatus further including a first sound source separator configured to receive the respective first surrounding sounds converted into the frequency domain, and to separate a first voice signal and the remaining signals except for the first voice signal from the input respective first surrounding sounds, and a second sound source separator configured to receive the respective second surrounding sounds converted into the frequency domain, and to separate a second voice signal and the remaining signals except for the second voice signal from the input respective second surrounding sounds.

An embodiment of the present disclosure may be a signage apparatus further including a beam former configured to beam-form the first voice signal separated by the first sound source separator and the second voice signal separated by the second sound source separator based on the user's position.

An embodiment of the present disclosure may be a signage apparatus further including a noise remover configured to remove noise from the voice signal output from the beam former.

An embodiment of the present disclosure may be a signage apparatus in which the left microphone group is a first directional microphone, and the right microphone group is a second directional microphone, and the adjuster adjusts the first and second directional microphones so that each direction of the first directional microphone and the second directional microphone faces the user's position.

An embodiment of the present disclosure may be a signage apparatus further including a converter configured to convert the surrounding sound of the time domain obtained through the first directional microphone and the second directional microphone, respectively, into the frequency domain, a sound source separator configured to separate a voice signal and the remaining signals except for the voice signal from the respective surrounding sounds converted into the frequency domain, and a noise remover configured to remove noise from the voice signal.

An embodiment of the present disclosure may be a signage apparatus further including a controller configured to search for service information corresponding to a touch or a voice signal from a memory to provide it through the display panel, in response that the touch from the user through the display panel is input, or the user's voice signal is extracted from the obtained surrounding sound through the left microphone group and the right microphone group.

An embodiment of the present disclosure may be a signage apparatus in which in response that a difference between the time point at which the touch is input and the time point at which the voice signal is extracted is smaller than a predetermined time, the controller ignores the touch, and provides the service information corresponding to the voice signal.

An embodiment of the present disclosure may be an operation method of a signage apparatus configured to recognize a voice including, sensing a user located within a predetermined distance with respect to a display panel, and confirming the user's position, and adjusting the arrangement of a left microphone group and a right microphone group installed on both side surfaces of the display panel, respectively, based on the user's position, respectively, and each of the left microphone group and the right microphone group includes a first non-directional microphone located at a distance relatively close to the display panel and a second non-directional microphone located at a distance relatively far away from the display panel.

An embodiment of the present disclosure may be an operation method of a signage apparatus in which the adjusting includes generating a first virtual line by connecting the first microphone and the second microphone, which have been spaced at a predetermined interval apart from each other and installed at the same height, generating a second virtual line by connecting the center of the first virtual line and the user's position, and adjusting the arrangement of the first microphone and the second microphone so that the first virtual line and the second virtual line are perpendicular to each other.

An embodiment of the present disclosure may be an operation method of a signage apparatus in which the adjusting further includes determining the arrangement angle between the lateral direction of the display panel and the first virtual line according to the arrangement adjustment of the first microphone and the second microphone, and the determining the arrangement angle includes determining the wider the width of the display panel is, the larger the arrangement angle is, and the farther the distance from the display panel to the user's position is, the smaller the arrangement angle is.

An embodiment of the present disclosure may be an operation method of a signage apparatus further including, after the adjusting the arrangement, respectively, converting a first surrounding sound of a time domain obtained through the first microphone of each of the left microphone group and the right microphone group, and a second surrounding sound of the time domain obtained through the second microphone of each of the left microphone group and the right microphone group into a frequency domain.

An embodiment of the present disclosure may be an operation method of a signage apparatus further including separating a first voice signal and the remaining signals except for the first voice signal from the respective first surrounding sounds converted into the frequency domain, and separating a second voice signal and the remaining signals except for the second voice signal from the respective second surrounding sounds converted into the frequency domain.

An embodiment of the present disclosure may be an operation method of a signage apparatus further including beam-forming the first voice signal and the second voice signal based on the user's position, and removing noise from the voice signal output as the beam-formed result.

An embodiment of the present disclosure may be an operation method of a signage apparatus further including when the left microphone group is a first directional microphone, and the right microphone group is a second directional microphone, adjusting the first and second directional microphones so that each direction of the first directional microphone and the second directional microphone faces the user's position.

An embodiment of the present disclosure may be an operation method of a signage apparatus further including converting the surrounding sound of the time domain obtained through the first directional microphone and the second directional microphone, respectively, into the frequency domain, separating a voice signal and the remaining signals except for the voice signal from the respective surrounding sounds converted into the frequency domain, and removing noise from the voice signal.

In addition, other methods and other systems for implementing the present disclosure, and a computer-readable medium for storing a computer program for executing the above method may be further provided.

Other aspects, features, and advantages other than those described above will become apparent from the following drawings, claims, and detailed description of the present disclosure.

According to the present disclosure, it is possible to adjust the arrangement of first and second microphones in a left microphone group and first and second microphones in a right microphone group installed at both side surfaces of a display panel, respectively, based on the user's position, and to extract a voice signal having improved sound quality from surrounding sounds obtained, respectively, through the adjusted left microphone group and right microphone group through a signal processing processes (for example, Time Frequency (T-F) conversion, sound source separation, beam-forming, or noise removal), thereby accurately recognizing the voice.

According to the present disclosure, it is possible to install a first directional microphone as a left microphone group and a second directional microphone as a right microphone group on both side surfaces of a display panel, thereby reducing the width of a signage apparatus by further reducing a space where the microphone is installed compared to when first and second microphones requiring a spacing distance therebetween are installed, and accurately recognizing the user's voice even while simplifying a signal processing process of extracting a voice signal from surrounding sounds obtained through first and second directional microphones.

In addition, according to the present disclosure, it is possible to adjust the arrangement of microphones installed on both side surfaces of a display panel based on at least one information of the distance from the display panel to the user's position (that is, an utterance distance) and the width of the display panel, thereby accurately recognizing the user's voice even if the user's position is changed each time, or the width of the display panel is variously produced.

### BRIEF DESCRIPTION OF THE DRAWINGS

FIG. 1 is an exemplary diagram illustrating a driving environment of a signage apparatus including a signage apparatus, a user terminal, a server, and a network configured to connect them with each other according to an embodiment of the present disclosure.

FIG. 2 is a diagram illustrating a configuration of a signage apparatus according to an embodiment of the present disclosure.

FIG. 3 is a diagram illustrating an example of a configuration of a voice recognizer in a signage apparatus according to an embodiment of the present disclosure.

FIG. 4 is a diagram illustrating an example of the arrangement of a microphone in a signage apparatus according to an embodiment of the present disclosure.

FIG. 5 is a diagram for explaining an example of a process of processing a voice in a signage apparatus according to an embodiment of the present disclosure.

FIG. 6 is a diagram illustrating another example of the configuration of the voice recognizer in the signage apparatus according to an embodiment of the present disclosure.

FIG. 7 is a diagram illustrating another example of the microphone arrangement in a signage apparatus according to an embodiment of the present disclosure.

FIG. 8 is a diagram for explaining an example of a process of processing a voice in a signage apparatus according to an embodiment of the present disclosure.

FIG. 9 is a diagram for explaining an example of providing service information in a signage apparatus according to an embodiment of the present disclosure.

FIG. 10 is a flowchart illustrating an operation method of a signage apparatus according to an embodiment of the present disclosure.

### DETAILED DESCRIPTION

Advantages and features of the present disclosure and methods for achieving them will become apparent from the descriptions of aspects hereinbelow with reference to the accompanying drawings. However, the description of particular example embodiments is not intended to limit the present disclosure to the particular example embodiments disclosed herein, but on the contrary, it should be understood that the present disclosure is to cover all modifications, equivalents and alternatives falling within the spirit and scope of the present disclosure. The example embodiments disclosed below are provided so that the present disclosure will be thorough and complete, and also to provide a more complete understanding of the scope of the present disclosure to those of ordinary skill in the art. In the interest of clarity, not all details of the relevant art are described in detail in the present specification in so much as such details are not necessary to obtain a complete understanding of the present disclosure.

The terminology used herein is used for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “includes,” “including,” “containing,” “has,” “having” or other variations thereof are inclusive and Accordingly specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally only used to distinguish one element from another.

Hereinafter, embodiments of the present disclosure will be described in detail with reference to the accompanying drawings. Like reference numerals designate like elements throughout the specification, and overlapping descriptions of the elements will not be provided.

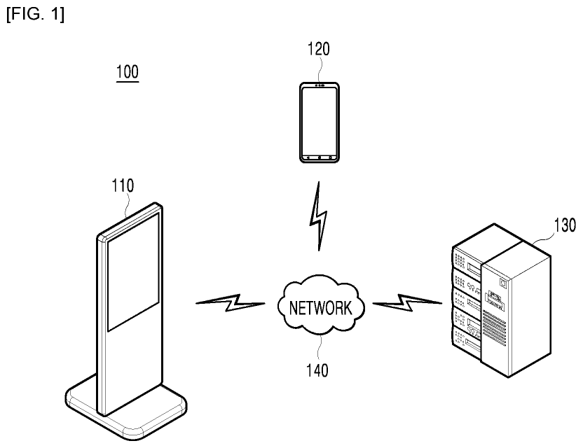

FIG. 1 is an exemplary diagram illustrating a driving environment of a signage apparatus including a signage apparatus, a user terminal, a server, and a network configured to connect them with each other according to an embodiment of the present disclosure.

Referring to FIG. 1, a driving environment 100 of a signage apparatus may include a signage apparatus 110, a user terminal 120, a server 130, and a network 140.

The signage apparatus 110 may be, for example, installed in various places (for example, a place with large floating populations, or to stay for a certain time, such as a terminal, a government office, a bus stop, a department store, a subway, an airport, a hotel, a hospital, a cinema, a restaurant, a shopping mall, or a shop), and may provide service information (for example, information on weather, traffic, advertisements, surrounding tourist attractions, a famous restaurant, a bank, a hospital, payments, or the like) corresponding to the search command when receiving a search command from the user. For example, when receiving a touch from the user through a display panel, or obtaining a voice signal from the user, the signage apparatus 110 may provide service information corresponding to the touch or the voice signal. When obtaining the voice signal, the signage apparatus 110 may obtain surrounding sounds by using microphones installed on both side surfaces of the display panel, and extract the voice signal of the user from the obtained surrounding sounds.

The signage apparatus 110 may search the service information corresponding to the touch (or voice signal) from an internal memory to provide it through the display panel, or request the service information corresponding to the touch (or voice signal) to the server 130, and provide the service information received from the server 130 in response to the request through the display panel.

In addition, the signage apparatus 110 may provide to the user terminal 120 through a network in interlock with the request for service information from the user terminal 120, such that the user may easily use the provided service information without having to memorize the service information or to memo separately.

The user terminal 120 may be, as a terminal possessed by the user, for example, a smartphone, a notebook, a tablet PC, a smart TV, a mobile phone, a personal digital assistant (PDA), a laptop, a media player, an e-book terminal, a digital broadcasting terminal, a navigation device, a MP3 player, a digital camera, a home appliance, and other mobile or non-mobile computing devices, but is not limited thereto. In addition, the user terminal 120 may be a wearable terminal such as a watch, glasses, a hair band, and a ring having a communication function and a data processing function. The user terminal 120 is not limited to the above description, and a terminal capable of web browsing may be the user terminal 120 without limitation.

The server 130 may be a database server that provides a big data necessary for applying various artificial intelligence algorithms, and various service information based on the big data. When receiving a request for the service information corresponding to the touch or the voice signal from the signage apparatus 110, the server 130 may analyze the touch and the voice signal, obtain the service information associated with the analysis result by using the artificial intelligence algorithm, and provide the obtained service information to the signage apparatus 110.

Here, artificial intelligence refers to an area of computer engineering science and information technology that studies methods to make computers mimic intelligent human behaviors such as reasoning, learning, self-improving, and the like.

In addition, artificial intelligence (AI) does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed. More specifically, machine learning is a technology that investigates and builds systems, and algorithms for such systems, which are capable of learning, making predictions, and enhancing their own performance on the basis of experiential data. Machine learning algorithms, rather than only executing rigidly-set static program commands, may be used to take an approach that builds models for deriving predictions and decisions from inputted data.

The network 140 may perform the connection between the signage apparatus 110, the user terminal 120, and the server 130. The network 140 may include a wired network such as a local area network (LAN), a wide area network (WAN), a metropolitan area network (MAN), or an integrated service digital network (ISDN), and a wireless network such as a wireless LAN, a CDMA, Bluetooth®, or satellite communication, but the present disclosure is not limited to these examples. In addition, the network 140 may transmit and receive information using short distance communication and/or long distance communication. The short-range communication may include Bluetooth®, radio frequency identification (RFID), infrared data association (IrDA), ultra-wideband (UWB), ZigBee, and Wi-Fi (wireless fidelity) technologies, and the long-range communication may include code division multiple access (CDMA), frequency division multiple access (FDMA), time division multiple access (TDMA), orthogonal frequency division multiple access (OFDMA), and single carrier frequency division multiple access (SC-FDMA).

The network 140 may include connection of network elements such as hubs, bridges, routers, switches, and gateways. The network 140 may include one or more connected networks, for example, a multi-network environment, including a public network such as an internet and a private network such as a safe corporate private network. Access to the network 140 may be provided via one or more wired or wireless access networks. Furthermore, the network 140 may support 5G communication and/or an Internet of things (IoT) network for exchanging and processing information between distributed components such as objects.

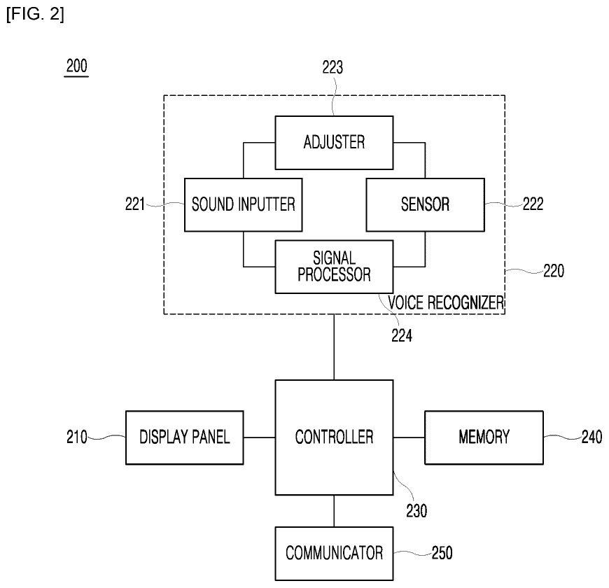

FIG. 2 is a diagram illustrating a configuration of a signage apparatus according to an embodiment of the present disclosure.

Referring to FIG. 2, a signage apparatus 200 according to an embodiment of the present disclosure may include a display panel 210, a voice recognizer 220, a controller 230, a memory 240, and a communicator 250.

The display panel 210 may perform an input or output interface function, and for example, when receiving a touch from the user, the display panel 210 may output service information corresponding to the touch under the control of the controller 230. In addition, when recognizing a voice signal through the voice recognizer 220, for example, the display panel 210 may output service information corresponding to the voice signal under the control of the controller 230.

The voice recognizer 220 may include a sound inputter 221, a sensor 222, an adjuster 223, and a signal processor 224.

The sound inputter 221 may include microphones (for example, a plurality of non-directional microphones or one directional microphone) located on both side surfaces of the display panel 210, respectively. Here, the sound inputter 221 may be, for example, located inside the frame of the signage apparatus 200, and a part of the microphone in the sound inputter 221 may be exposed to the outside so as to obtain the surrounding sounds better. In addition, the sound inputter 221 may be, for example, located inside the frame of the signage apparatus 200, but is not limited thereto, and may also be located outside the frame of the signage apparatus 200.

The sensor 222 may sense the user located within a predetermined distance with respect to the display panel 210, and confirm the user's position.

The adjuster 223 may adjust the microphone in the sound inputter 221 in the direction of the user's position.

The signal processor 224 may obtain surrounding sounds through the adjusted microphone in the sound inputter 221, and separate a voice signal from the surrounding sounds. At this time, the voice signal may include a keyword, a sentence, and the like.

The controller 230 may use, as a method for receiving a search command (or, information request command) from the user, a touch recognition method for receiving a touch from the user through the display panel 210 and a voice recognition method for obtaining the voice signal from the user through the voice recognizer 220. At this time, the controller 230 may set the voice recognition method by default as the method for receiving the search command, but is not limited thereto. For example, the controller 230 may set the touch recognition method or set both the voice recognition method and the touch recognition method by default.

When receiving the touch from the user through the display panel 210 or obtaining the voice signal through the voice recognizer 220, the controller 230 may search for the service information (for example, information on weather, traffic, advertisements, surrounding tourist attractions, a famous restaurant, a bank, a hospital, payments, etc.) corresponding to the input touch or the obtained voice signal from the memory 240, or obtain it from the server through the communicator 250 to provide it through the display panel 210. For example, when the voice signal obtained through the voice recognizer 220 is ‘tell the surrounding famous restaurant information,’ the controller 230 may search for the famous restaurant information located in the range set with respect to the user's position from the memory 240, or may obtain it from the server through the communicator 250 to provide it through the display panel 210.

In the case of using both the voice recognition method and the touch recognition method as a method for receiving a search command, the controller 230 may provide the service information corresponding to the touch or the voice signal according to a predetermined reference (for example, a recognition method in which a set priority is high), when the difference between the time point at which the touch is input and the time point at which the voice signal is extracted is smaller than a predetermined time.

For example, when the voice recognition method is set to have a higher priority than the touch recognition method, the controller 230 may ignore the touch and provide the service information corresponding to the voice signal, when the difference between the time point at which the touch is input and the time point at which the voice signal is extracted is smaller than a predetermined time (for example, 1 second).

In addition, the controller 230 may provide the service information to the user terminal possessed by the user through the communicator 250 so as to easily use the service information. At this time, the controller 230 may receive identification information of the user terminal (for example, a product number of the user terminal and a phone number of the user terminal) through, for example, a short-range communication or a mobile communication network, recognize the user terminal by using the identification information, and provide the service information to the recognized user terminal.

Meanwhile, for another example, when the arrangement (for example, a predetermined arrangement angle, adjustment angle) of the microphone in the sound inputter 221 is fixed, the controller 230 may provide the information on the user's position corresponding to the fixed microphone to the outputter (not illustrated) (for example, a display panel, a speaker, or a laser beam). At this time, the controller 230 may, for example, guide to move the user's current position through the speaker (move the position so as to adjust the utterance distance), or display the most suitable position through the laser beam.

In addition, when not accurately extracting the voice signal from the signal processor 224 (for example, when the intensity of the voice signal is smaller than a predetermined value (or, the intensity of surrounding noise), or as the pronunciation is not correct, when the voice signal is not identified), the controller 230 may guide the user to speak the voice loudly, or to speak the voice of the accurate pronunciation through the outputter.

The memory 240 may store various service information. The memory 240 may be periodically updated based on the service information obtained from the server under the control of the controller 230.

The communicator 250 may communicate with the server or the user terminal under the control of the controller 230.

FIG. 3 is a diagram illustrating an example of a configuration of a voice recognizer in a signage apparatus according to an embodiment of the present disclosure.

Referring to FIG. 3, a voice recognizer 300 may include a sound inputter 310, a sensor 320, an adjuster 330, and a signal processor 340.

The sound inputter 310 may include, for example, a left microphone group and a right microphone group. At this time, the left microphone group and the right microphone group may be located on both side surfaces of the display panel. Here, each of the left microphone group and the right microphone group may include a first microphone located at a relatively closer distance to the display panel and a second microphone located at a relatively far distance away from the display panel. Here, the first microphone and the second microphone may be a non-directional microphone. In addition, the first microphone and the second microphone may be spaced at a predetermined distance (for example, 6 cm) apart from each other, and may be installed at the same height of the display panel.

In addition, the left microphone group and the right microphone group may include two first and second microphones, respectively, but are not limited thereto and may also include more microphones.

The sensor 320 may sense the user located within a predetermined distance with respect to the display panel, and confirm the user's position (for example, distance, direction, etc. from the display panel).

The adjuster 330 may adjust the arrangement of the left microphone group and the right microphone group based on the user's position, respectively. At this time, the adjuster 330 may first generate a first virtual line by connecting the first microphone and the second microphone, which have been spaced at a predetermined interval apart from each other and installed at the same height, and generate a second virtual line by connecting the center of the first virtual line and the user's position. At this time, the adjuster 330 may adjust the arrangement of the first microphone and the second microphone so that the first virtual line and the second virtual line are perpendicular to each other, thereby calibrating the phase difference according to the user's phase shift than before the arrangement of the first and second microphones is adjusted (for example, the first and second microphones have been located in parallel with the lateral direction (or, horizontal direction) of the display panel).

The adjuster 330 may determine the arrangement angle between the lateral direction of the display panel and the first virtual line according to the arrangement adjustment of the first microphone and the second microphone, and the wider the width of the display panel is, the larger the arrangement angle may be determined, and the farther the distance from the display panel to the user's position is, the smaller the arrangement angle may be determined.

The left microphone group and the right microphone group in the sound inputter 310 whose the arrangement has been adjusted by the adjuster 330 may obtain surrounding sounds. At this time, the first microphone in the left microphone group and the first microphone in the right microphone group may simultaneously obtain the surrounding sounds including the user's voice signal. In addition, the second microphone in the left microphone group and the second microphone in the right microphone group may simultaneously obtain the surrounding sounds including the user's voice signal.

The signal processor 340 may obtain the surrounding sounds through the left microphone group and the right microphone group whose arrangement has been adjusted in the sound inputter 310, and separate the voice from the surrounding sounds. The signal processor 340 may include a converter 341, a first sound source separator 342, a second sound source separator 343, a beam former 344, and a noise remover 345.

The converter 341 may convert a first surrounding sound of the time domain obtained through the first microphone of each of the left microphone group and the right microphone group into the frequency domain. In addition, the converter 341 may convert a second surrounding sound of the time domain obtained through the second microphone of each of the left microphone group and the right microphone group into the frequency domain.

The first sound source separator 342 may receive the respective first surrounding sounds converted into the frequency domain from the converter 341, and separate a first voice signal and the remaining signals except for the first voice signal from the input respective first surrounding sounds, thereby removing surrounding noise.

The second sound source separator 343 may receive the respective second surrounding sounds converted into the frequency domain from the converter 341, and separate a second voice signal and the remaining signals except for the second voice signal from the input respective second surrounding sounds, thereby removing surrounding noise.

That is, the first sound source separator 342 and the second sound source separator 343 may be, for example, a dual channel blind separator, may assign signals having similar characteristics to one group, and assign the remaining signals having no similar characteristics to other groups to separate the voice signal and the remaining signals from the surrounding signal, thereby primarily removing the surrounding noise from the surrounding signal.

The beam former 344 may beamform the first voice signal separated by the first sound source separator 342 and the second voice signal separated by the second sound source separator 343 based on the user's position. For example, the beam former 344 may maintain the intensity of the signal in the direction of the user's position with respect to the first voice signal and the second voice signal based on the user's position, and reduce the intensity of the signal in the direction different from the direction of the user's position to output the voice signal, thereby secondarily removing the surrounding noise, which have not been removed from the first sound source separator 342 and the second sound source separator 343, with respect to the first voice signal and the second voice signal.

The noise remover 345 may remove noise from the voice signal output from the beam former 344, thereby thirdly removing the surrounding noise that has not been removed by the beam former 344.

Accordingly, the signal processor 340 may remove the surrounding noise three times through the first and second sound source separators 342, 343, the beam former 344, and the noise remover 345 to extract the voice signal having improved sound quality, thereby accurately recognizing the voice.

Meanwhile, the signal processor 340 includes the beam former 344 arranged after the first and second sound source separators 342, 343, but is not limited thereto, and may include the beam former 344 arranged before the first and second sound source separators 342, 343. That is, the arrangement order of the first and second sound source separators 342, 343 and the beam former 344 may be interchangeably changed.

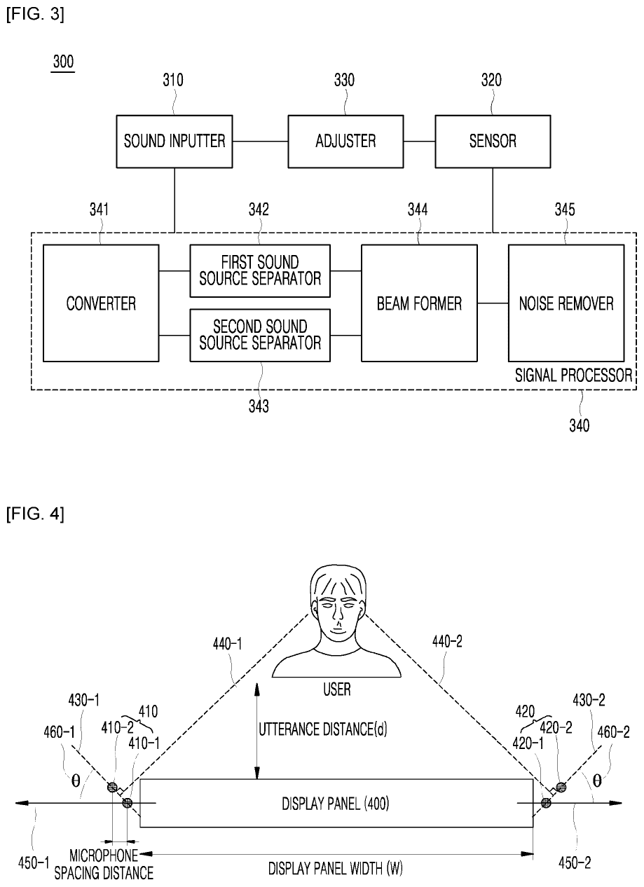

FIG. 4 is a diagram illustrating an example of the microphone arrangement in a signage apparatus according to an embodiment of the present disclosure. Here, FIG. 4 is a diagram when viewing the signage apparatus from the top to the bottom.

Referring to FIG. 4, for example, when sensing the user located in front of a display panel 400, the signage apparatus may confirm the user's position, and adjust the arrangement of a left microphone group 410 and a right microphone group 420 installed on both side surfaces of the display panel 400, respectively.

At this time, the signage apparatus may generate first virtual lines 430-1, 430-2 by connecting first microphones 410-1, 420-1 and second microphones 410-2, 420-2, which have been spaced at a predetermined interval apart from each other and installed at the same height, with respect to the left microphone group 410 and the right microphone group 420, respectively. Specifically, the signage apparatus may generate the first virtual line_#1 430-1 by connecting the first microphone_#1 410-1 and the second microphone_#1 410-2 in the first left microphone group 410, and generate the first virtual line_#2 430-2 by connecting the first microphone_#2 420-1 and the second microphone_#2 420-2 in the right microphone group 420.

The signage apparatus may generate a second virtual line_#1 440-1 by connecting the center of the first virtual line_#1 430-1 and the user's position, and generate a second virtual line_#2 440-2 by connecting the center of the first virtual line_#2 430-2 and the user's position.

At this time, the signage apparatus may adjust the arrangement of the first microphone and the second microphone so that the first virtual line and the second virtual line are perpendicular to each other. That is, the signage apparatus may adjust the arrangement of the first microphone_#1 410-1 and the second microphone_#1 410-2 in the left microphone group 410 so that the first virtual line_#1 430-1 and the second virtual line_#1 440-1 are perpendicular to each other. In addition, the signage apparatus may adjust the arrangement of the first microphone_#2 420-1 and the second microphone_#2 420-2 in the right microphone group 420 so that the first virtual line_#2 430-2 and the second virtual line_#2 440-2 are perpendicular to each other.

The signage apparatus may determine the arrangement angle (Q) between the lateral directions 450-1, 450-2 of the display panel 400 and the first virtual lines 430-1, 430-2 according to the arrangement adjustment of the first microphones 410-1, 420-1 and the second microphones 410-2, 420-2. That is, the signage apparatus may determine the arrangement angle 460-1 between the lateral direction 450-1 of the display panel 400 and the first virtual line_#1 430-1, and determine the arrangement angle 460-2 between the lateral direction 450-2 of the display panel 400 and the first virtual line_#2 430-2, according to the arrangement adjustment of the first microphones 410-1, 420-1 and the second microphones 410-2, 420-2.

At this time, in the signage apparatus, the wider the width (w) of the display panel 400 is, the larger the arrangement angles 460-1, 460-2 may be determined, and the farther the distance (d) from the display panel to the user's position is, the smaller the arrangement angles 460-1, 460-2 may be determined. Here, the arrangement angle may be expressed by the following Equation 1.

$$θ = {tan}^{- 1} ( \frac{w}{d * 2} ) \qquad Equation 1$$

Where, the θ refers to the arrangement angle, the w refers to the width of the display panel, and the d refers to the utterance distance (for example, 50 to 70 cm).

FIG. 5 is a diagram for explaining an example of a process of processing a voice in a signage apparatus according to an embodiment of the present disclosure.

Referring to FIG. 5, in order to recognize the user's utterance voice, the signage apparatus may include a signal processor 530 configured to extract the voice from the surrounding sound obtained through a left microphone group 510 and a right microphone group 520 installed on both side surfaces of the display panel 500, respectively.

The signal processor 530 may include, for example, a time frequency (TF) converter 540, a first dual channel blind separator 550-1, a second dual channel blind separator 550-2, a beam former 560, and a noise remover 570.

The TF converter 540 may convert a first surrounding sound_#1 of the time domain obtained through a first microphone 510-1 in a left microphone group 510 and a first surrounding sound_#2 of the time domain obtained through a first microphone 520-1 in a right microphone group 520 into a frequency domain. In addition, the TF converter 540 may convert a second surrounding sound_#1 of the time domain obtained through a second microphone 510-2 in the left microphone group 510 and a second surrounding sound_#2 of the time domain obtained through a second microphone 520-2 in the right microphone group 520 into the frequency domain.

The first dual channel blind separator 550-1 may receive the first surrounding sound_#1 and the first surrounding sound_#2 converted into the frequency domain, and separate a first voice signal and the remaining signals except for the first voice signal from the input first surrounding sound_#1 and first surrounding sound_#2.

The second dual channel blind separator 550-2 may receive the second surrounding sound_#1 and the second surrounding sound_#2 converted into the frequency domain, and separate a second voice signal and the remaining signals except for the second voice signal from the input second surrounding sound_#1 and second surrounding sound_#2.

The beam former 560 may beamform the first voice signal separated by the first dual channel blind separator 550-1 and the second voice signal separated by the second dual channel blind separator 550-2 based on the user's position.

The noise remover 570 may remove noise from the voice signal (beam-formed voice signal) output from the beam former 560 to output a voice signal having improved sound quality.

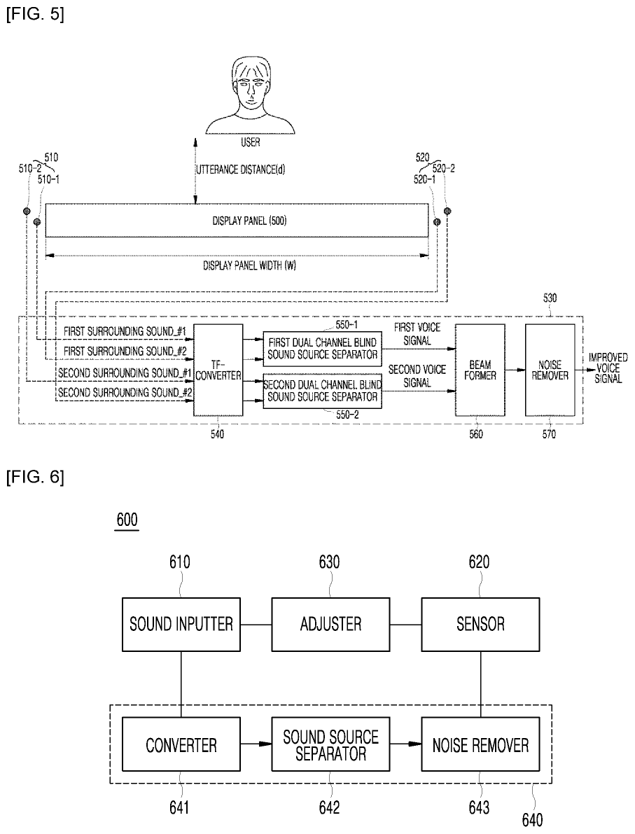

FIG. 6 is a diagram illustrating another example of a configuration of a voice recognizer in a signage apparatus according to an embodiment of the present disclosure.

Referring to FIG. 6, the voice recognizer 600 may include a sound inputter 610, a sensor 620, an adjuster 630, and a signal processor 640.

The sound inputter 610 may include, for example, a first directional microphone as a left microphone group, and a second directional microphone as a right microphone group. At this time, as the first directional microphone and the second directional microphone are located on both side surfaces of the display panel respectively, it is possible to further reduce the width of the signage apparatus by reducing a space where the microphone is installed compared to when installing the non-directional first and second microphones requiring a spacing distance therebetween.

The sensor 620 may sense the user located within a predetermined distance with respect to the display panel, and confirm the user's position.

The adjuster 630 may adjust the first and second directional microphones so that each direction of the first directional microphone and the second directional microphone faces the user's position.

The first directional microphone and the second directional microphone in the sound inputter 310 whose arrangement has been adjusted by the adjuster 630 may obtain surrounding sounds. At this time, the first directional microphone and the second directional microphone may simultaneously obtain the surrounding sounds including the user's voice signal. In addition, the first directional microphone and the second directional microphone may obtain sound as it is from a specific direction (for example, the direction of the user's position), and obtain relatively fewer sounds from the direction different from the specific direction, thereby obtaining the beam-forming effect. Accordingly, the signal processor 640 may omit the beam-forming process when processing the surrounding sounds obtained through the first directional microphone and the second directional microphone.

The signal processor 640 may obtain surrounding sounds through the first directional microphone and the second directional microphone in the sound inputter 610 whose directions have been adjusted, and separate voice from the surrounding sounds. The signal processor 640 may include a converter 641, a sound source separator 642, and a noise remover 643.

The converter 641 may convert the surrounding sound of the time domain obtained through each of the first directional microphone and the second directional microphone into the frequency domain.

The sound source separator 642 may separate the voice signal and the remaining signals except for the voice signal from the respective surrounding sounds converted into the frequency domain.

The noise remover 643 may remove noise from the voice signal.

FIG. 7 is a diagram illustrating another example of the microphone arrangement in a signage apparatus according to an embodiment of the present disclosure. Here, FIG. 7 is a diagram when viewing the signage apparatus from the top to the bottom.

Referring to FIG. 7, as in FIG. 7A, for example, when sensing the user located in front of a display panel 700, the signage apparatus may confirm the user's position, and adjust a first directional microphone 710 and a second directional microphone 720 so that each direction of the first directional microphone 710 and the second directional microphone 720 located on both side surfaces of the display panel 700, respectively, faces the user's position.

As the signage apparatus adjusts the first directional microphone 710 and the second directional microphone 720 so as to face the user's position, the signage apparatus may determine an adjustment angle 740-1 between the lateral direction 730-1 of the display panel 700 and the first directional microphone 710 and an adjustment angle 740-2 between the lateral direction 730-2 of the display panel 700 and the second directional microphone 720. At this time, in the signage apparatus, the wider the width of the display panel 700 is, the smaller the adjustment angles 740-1, 740-2 may be determined, and the farther the distance (utterance distance) from the display panel to the user's position is, the larger the adjustment angles 740-1, 740-2 may be determined.

At this time, the first directional microphone 710 and the second directional microphone 720 may obtain sound from a specific direction (for example, 0° direction, the direction of the user's position) as it is by using a beam pattern as shown in FIG. 7B, and obtain relatively fewer sounds from the direction different from the specific direction.

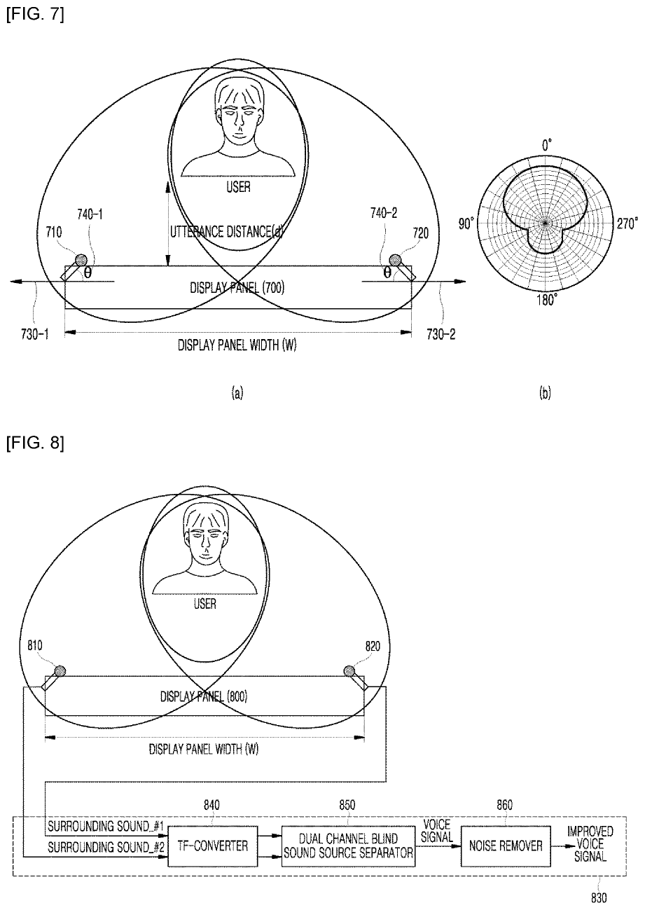

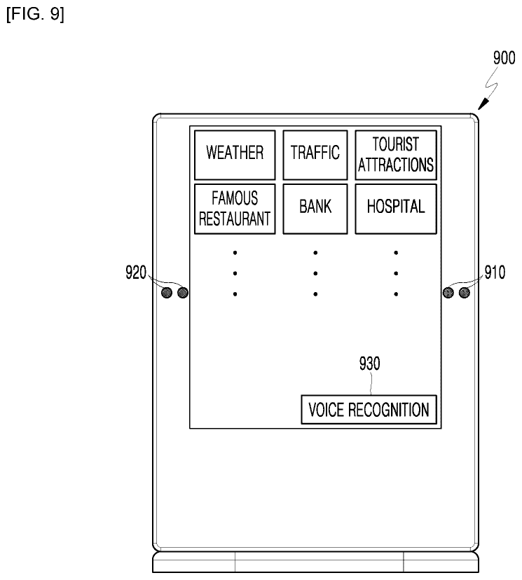

FIG. 8 is a diagram for explaining an example of a process of processing a voice in a signage apparatus according to an embodiment of the present disclosure.

Referring to FIG. 8, the signage apparatus may include a signal processor 830 configured to extract a voice from the surrounding sounds obtained through a first directional microphone 810 and a second directional microphone 820 located on both side surfaces of a display panel 800, respectively, in order to recognize the user's utterance voice.

The signal processor 830 may include, for example, a time frequency (T-F) converter 840, a dual channel blind separator 850, and a noise remover 860.

The TF converter 840 may convert a surrounding sound_#1 of the time domain obtained through the first directional microphone 810 and a surrounding sound_#2 of the time domain obtained through the second directional microphone 820 into the frequency domain.

The dual channel blind separator 850 may receive the surrounding sound_#1 and the surrounding sound_#2 converted into the frequency domain, and separate a voice signal and the remaining signals except for the voice signal from the input surrounding sound_#1 and surrounding sound_#2.

The noise remover 860 may remove noise from the voice signal output from the dual channel blind separator 850 to output the improved voice signal.

FIG. 9 is a diagram for explaining an example of providing service information in a signage apparatus according to an embodiment of the present disclosure.

Referring to FIG. 9, a signage apparatus 900 may be installed in, for example, a public place or a commercial space, and when receiving a search command from a user, the signage apparatus 900 may provide service information (for example, information on weather, traffic, tourist attractions, a famous restaurant, a bank, a hospital, advertisements, and the like) corresponding to the search command. The signage apparatus 900 may use a touch recognition method for receiving a touch from a user through a display panel and a voice recognition method for obtaining a voice signal from the user through a voice recognizer, as a method for receiving the search command.

When obtaining the voice signal, the signage apparatus 900 may obtain surrounding sounds by using a plurality of non-directional microphones 910, 920 or directional microphones (not illustrated) installed on both side surfaces of the display panel, respectively, and extract a voice signal of the user from the obtained surrounding sounds.

The signage apparatus 900 may set the voice recognition method by default as the method for receiving the search command from the user, but is not limited thereto. For example, the signage apparatus 900 may set the touch recognition method, or set both the voice recognition method and the touch recognition method, by default.

In the case that the touch recognition method has been set by default, when receiving a voice recognition button 930, the signage apparatus 900 may replace the touch recognition method with the voice recognition method, or use both the touch recognition method and the voice recognition method, as the method for receiving the search command. On the other hand, in the case that the voice recognition method has been set by default, when receiving a touch button (not illustrated), the signage apparatus 900 may replace the voice recognition method with the touch recognition method, or use both the voice recognition method and the touch recognition method, as the method for receiving the search command.

In addition, as the method for receiving the search command, when using both the voice recognition method and the touch recognition method, the signage apparatus 900 may provide service information corresponding to a touch or voice signal according to a predetermined reference (for example, a recognition method in which a predetermined priority is high), when the difference between the time point at which the touch is input and the time point at which the voice signal is extracted is smaller than a predetermined time. For example, the signage apparatus 900 may ignore the touch, and provide service information corresponding to the voice signal, when the voice recognition method is set to have a higher priority than the touch recognition method.

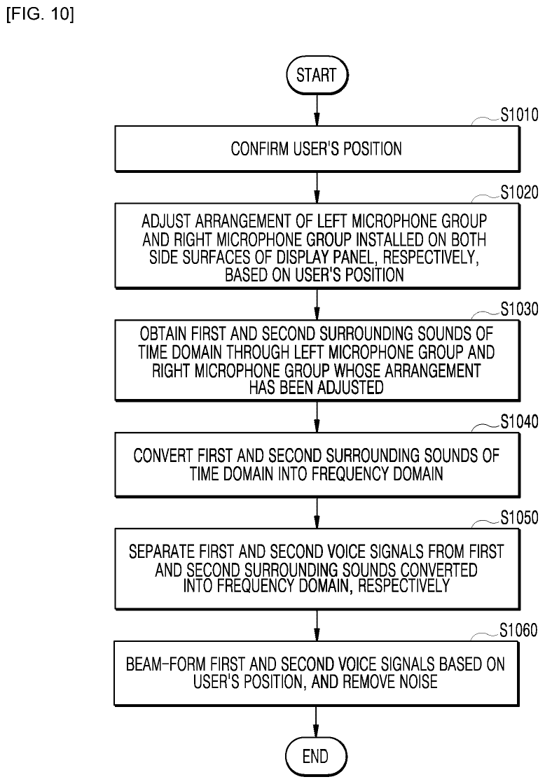

FIG. 10 is a flowchart illustrating an operation method of a signage apparatus according to an embodiment of the present disclosure.

Referring to FIG. 10, in operation 51010, the signage apparatus may sense a user located within a predetermined distance with respect to a display panel, and confirm the user's position.

In operation S1020, the signage apparatus may adjust the arrangement of a left microphone group and a right microphone group installed on both side surfaces of a display panel, respectively, based on the user's position. Here, each of the left microphone group and the right microphone group may include a first non-directional microphone located at a distance relatively close to the display panel and a second non-directional microphone located at a distance relatively far away from the display panel.

When the microphone arrangement is adjusted, the signage apparatus may first generate a first virtual line by connecting the first microphone and the second microphone, which are spaced at a predetermined interval apart from each other and installed at the same height, and generate a second virtual line by connecting the center of the first virtual line and the user's position. At this time, the signage apparatus may adjust the arrangement of the first microphone and the second microphone so that the first virtual line and the second virtual line are perpendicular to each other.

At this time, the signage apparatus may determine the arrangement angle between the lateral direction of the display panel and the first virtual line according to the arrangement adjustment of the first microphone and the second microphone. Here, in the signage apparatus, the wider the width of the display panel is, the larger the arrangement angle may be determined, and the farther the distance from the display panel to the user's position is, the smaller the arrangement angle may be determined.

In operation S1030, the signage apparatus may obtain a first surrounding sound and a second surrounding sound of the time domain through the left microphone group and the right microphone group whose arrangement has been adjusted. At this time, the signage apparatus may obtain the first surrounding sound of the time domain through the first microphone of each of the left microphone group and the right microphone group, and obtain the second surrounding sound of the time domain through the second microphone of each of the left microphone group and the right microphone group.

In operation S1040, the signage apparatus may convert the first surrounding sound of the time domain and the second surrounding sound of the time domain into the frequency domain.

In operation S1050, the signage apparatus may separate a first voice signal and a second voice signal from the first surrounding sound and the second surrounding sound converted into the frequency domain, respectively. At this time, the signage apparatus may separate the first voice signal and the remaining signals except for the first voice signal from each of the first surrounding sounds converted into the frequency domain, and separate the second voice signal and the remaining signals except for the second voice signal from each of the second surrounding sounds converted into the frequency domain.

In operation S1060, the signage apparatus may beamform the first voice signal and the second voice signal based on the user's position, and remove noise from the voice signal output as the beam-formed result, thereby extracting the voice signal having improved sound quality.

Subsequently, the signage apparatus may search the service information corresponding to the extracted voice signal from a memory, or receive it from a server to provide it through a display panel. In addition, the signage apparatus may receive a touch from the user through the display panel, and ignore the touch, and provide the service information corresponding to the voice signal, when the difference between the time point at which the touch is input and the time point at which the voice signal is extracted is smaller than a predetermined time.

Meanwhile, when the left microphone group is the first directional microphone, and the right microphone group is the second directional microphone, the signage apparatus may adjust the first and second directional microphones so that each direction of the first directional microphone and the second directional microphone faces the user's position.

Subsequently, the signage apparatus may convert the surrounding sound of the time domain obtained through the first directional microphone and the second directional microphone, respectively, into the frequency domain, and separate the voice signal and the remaining signals except for the voice signal from each of the surrounding sounds converted into the frequency domain and then, remove noise from the voice signal.

Embodiments according to the present disclosure described above may be implemented in the form of a computer program that may be executed through various components on a computer, and such a computer program may be recorded in a computer-readable medium. At this time, the media may be magnetic media such as hard disks, floppy disks, and magnetic tape, optical recording media such as CD-ROMs and DVDs, magneto-optical media such as floptical disks, and hardware devices specifically configured to store and execute program instructions, such as ROM, RAM, flash memory, and the like.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

As used in the present application (especially in the appended claims), the terms “a/an” and “the” include both singular and plural references, unless the context clearly conditions otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

Operations constituting the method of the present disclosure may be performed in appropriate order unless explicitly described in terms of order or described to the contrary. The present disclosure is not necessarily limited to the order of operations given in the description. All examples described herein or the terms indicative thereof (“for example,” etc.) used herein are merely to describe the present disclosure in greater detail. Accordingly, it should be understood that the scope of the present disclosure is not limited to the example embodiments described above or by the use of such terms unless limited by the appended claims. Accordingly, it should be understood that the scope of the present disclosure is not limited to the example embodiments described above or by the use of such terms unless limited by the appended claims. Also, it should be apparent to those skilled in the art that various alterations, substitutions, and modifications may be made within the scope of the appended claims or equivalents thereof.

Accordingly, technical ideas of the present disclosure are not limited to the above-mentioned embodiments, and it is intended that not only the appended claims, but also all changes equivalent to claims, should be considered to fall within the scope of the present disclosure.

What is claimed is:

1. A signage apparatus configured to recognize a voice, comprising:
a left microphone group and a right microphone group installed on both side surfaces of a display panel, respectively;
a sensor configured to sense a user located within a predetermined distance with respect to the display panel, and to confirm the user's position; and
an adjuster configured to adjust the arrangement of the left microphone group and the right microphone group, respectively, based on the user's position,
wherein each of the left microphone group and the right microphone group comprises a first microphone located at a distance relatively close to the display panel and a second microphone located at a distance relatively far away from the display panel.

2. The signage apparatus of claim 1,
wherein the adjuster
generates a first virtual line by connecting the first microphone and the second microphone, which have been spaced at a predetermined interval apart from each other and installed at the same height,
generates a second virtual line by connecting the center of the first virtual line and the user's position, and
adjusts the arrangement of the first microphone and the second microphone so that the first virtual line and the second virtual line are perpendicular to each other.

3. The signage apparatus of claim 2,
wherein the adjuster
determines the arrangement angle between the lateral direction of the display panel and the first virtual line according to the arrangement adjustment of the first microphone and the second microphone, and
the wider the width of the display panel is, the larger the arrangement angle is determined, and the farther the distance from the display panel to the user's position is, the smaller the arrangement angle is determined.

4. The signage apparatus of claim 1,
wherein the first microphone and the second microphone are a non-directional microphone.

5. The signage apparatus of claim 1, further comprising a converter configured to convert
a first surrounding sound of a time domain obtained through the first microphone of each of the left microphone group and the right microphone group, and
a second surrounding sound of the time domain obtained through the second microphone of each of the left microphone group and the right microphone group into a frequency domain.

6. The signage apparatus of claim 5, further comprising:
a first sound source separator configured to receive the respective first surrounding sounds converted into the frequency domain, and to separate a first voice signal and the remaining signals except for the first voice signal from the input respective first surrounding sounds; and
a second sound source separator configured to receive the respective second surrounding sounds converted into the frequency domain, and to separate a second voice signal and the remaining signals except for the second voice signal from the input respective second surrounding sounds.

7. The signage apparatus of claim 6, further comprising a beam former configured to beam-form the first voice signal separated by the first sound source separator and the second voice signal separated by the second sound source separator based on the user's position.

8. The signage apparatus of claim 7, further comprising a noise remover configured to remove noise from the voice signal output from the beam former.

9. The signage apparatus of claim 1,
wherein the left microphone group is a first directional microphone, and the right microphone group is a second directional microphone, and
wherein the adjuster adjusts the first and second directional microphones so that each direction of the first directional microphone and the second directional microphone faces the user's position.

10. The signage apparatus of claim 9, further comprising:
a converter configured to convert the surrounding sound of the time domain obtained through the first directional microphone and the second directional microphone, respectively, into the frequency domain;
a sound source separator configured to separate a voice signal and the remaining signals except for the voice signal from the respective surrounding sounds converted into the frequency domain; and
a noise remover configured to remove noise from the voice signal.

11. The signage apparatus of claim 1, further comprising a controller configured to
search for service information corresponding to a touch or a voice signal from a memory to provide it through the display panel,
in response that the touch from the user through the display panel is input, or the user's voice signal is extracted from the obtained surrounding sound through the left microphone group and the right microphone group.

12. The signage apparatus of claim 11,
wherein in response that a difference between the time point at which the touch is input and the time point at which the voice signal is extracted is smaller than a predetermined time,
the controller ignores the touch, and provides the service information corresponding to the voice signal.

13. An operation method of a signage apparatus configured to recognize a voice, comprising:
sensing a user located within a predetermined distance with respect to a display panel, and confirming the user's position; and
adjusting the arrangement of a left microphone group and a right microphone group installed on both side surfaces of the display panel, respectively, based on the user's position, respectively,
wherein each of the left microphone group and the right microphone group comprises a first non-directional microphone located at a distance relatively close to the display panel and a second non-directional microphone located at a distance relatively far away from the display panel.

14. The operation method of the signage apparatus of claim 13,
wherein the adjusting comprises
generating a first virtual line by connecting the first microphone and the second microphone, which have been spaced at a predetermined interval apart from each other and installed at the same height;
generating a second virtual line by connecting the center of the first virtual line and the user's position; and
adjusting the arrangement of the first microphone and the second microphone so that the first virtual line and the second virtual line are perpendicular to each other.

15. The operation method of the signage apparatus of claim 14,
wherein the adjusting further comprises determining the arrangement angle between the lateral direction of the display panel and the first virtual line according to the arrangement adjustment of the first microphone and the second microphone,
wherein the determining the arrangement angle comprises determining the wider the width of the display panel is, the larger the arrangement angle is, and the farther the distance from the display panel to the user's position is, the smaller the arrangement angle is.

16. The operation method of the signage apparatus of claim 13, further comprising, after the adjusting the arrangement, respectively, converting
a first surrounding sound of a time domain obtained through the first microphone of each of the left microphone group and the right microphone group, and
a second surrounding sound of the time domain obtained through the second microphone of each of the left microphone group and the right microphone group into a frequency domain.

17. The operation method of the signage apparatus of claim 16, further comprising:
separating a first voice signal and the remaining signals except for the first voice signal from the respective first surrounding sounds converted into the frequency domain; and
separating a second voice signal and the remaining signals except for the second voice signal from the respective second surrounding sounds converted into the frequency domain.

18. The operation method of the signage apparatus of claim 17, further comprising:
beam-forming the first voice signal and the second voice signal based on the user's position; and
removing noise from the voice signal output as the beam-formed result.

19. The operation method of the signage apparatus of claim 13, further comprising,
when the left microphone group is a first directional microphone, and the right microphone group is a second directional microphone,
adjusting the first and second directional microphones so that each direction of the first directional microphone and the second directional microphone faces the user's position.

20. The operation method of the signage apparatus of claim 19, further comprising:
converting the surrounding sound of the time domain obtained through the first directional microphone and the second directional microphone, respectively, into the frequency domain;
separating a voice signal and the remaining signals except for the voice signal from the respective surrounding sounds converted into the frequency domain; and
removing noise from the voice signal.
